(19) United States
(12) Patent Application Publication
(10) Pub. No.: US 2007/0204065 A1
(43) Pub. Date: Aug. 30, 2007

(54) Method and system for providing communication protocol interoperability

(76) Inventors: David C. Harton, Apex, NC (US); John K. Restrick JR., Palo Alto, CA (US); Yun-Chung Chen, Fremont, CA (US)

Correspondence Address: BAKER BOTTS L.L.P., 2001 ROSS AVENUE, SUITE 600, DALLAS, TX, 75201-2980, US

(21) Appl. No.: 11/364,755

(22) Filed: Feb. 27, 2006

(51) Int. Cl. G06F 15/16

(52) U.S. Cl. 709/246

(57) ABSTRACT

A method for providing communication protocol interoperability includes receiving a first request from a first endpoint for communication with a second endpoint. The first endpoint uses a first type of request of a first protocol, and the second endpoint uses a second type of request of a second protocol. The first type of request and first protocol are different than the second type of request and the second protocol. The method also includes retrieving a selected piece of information from a selected element of the first request. The selected element does not match an element of the second type of request. The method also includes generating a second request by mapping the selected piece of information of the first request to a selected element of the second type of request. The method also includes processing and sending the second request to the second endpoint based on the processing of the second request.

### TECHNICAL FIELD OF THE INVENTION

This invention relates generally to communications systems and, more particularly, to a method and system for providing communication protocol interoperability.

### BACKGROUND OF THE INVENTION

Historically, telecommunications have involved the transmission of voice and fax signals over a network dedicated to telecommunications, such as the Public Switch Exchange (PBX). Similarly, data communications between computers have been historically transmitted on a dedicated data network, such as a Local Area Network (LAN) or a Wide Area Network (WAN). Currently telecommunications and data transmissions are being merged into an integrated communication network using technology such as Voice over Internet Protocol (VoIP). As new technologies emerge that take advantage of the capabilities of this integrated communication network so do the protocols that enable these technologies.

Two such protocols used in facilitating communications between endpoints are the session initiation protocol (SIP) and the H.323 protocol. However, these protocols were developed independently of each other and the way they negotiate media differs in ways that can make interoperability difficult. For example, it may be the case that one feature of one protocol does not have a corresponding feature in the other protocol. Furthermore, differences in the timing and content of information flow in each protocol are such that there does not exist a simple common scheme to map the information flows to each other. For example, when building a SIP to H.323 protocol gateway one particular problem is that the H.323 flow does not include caller preference and the SIP flow does not include bearer capability. The purpose of bearer capability in H.323 and caller preference in SIP is not the same.

### SUMMARY OF THE INVENTION

In accordance with the present invention, a method and system for providing communication protocol interoperability is provided which substantially eliminates or reduces the disadvantages and problems associated with previous systems and methods.

In accordance with a particular embodiment of the present invention, a method for providing communication protocol interoperability includes, receiving a first request from a first endpoint for communication with a second endpoint. The first endpoint uses a first type of request of a first protocol, and the second endpoint uses a second type of request of a second protocol. The first type of request and first protocol are different than the second type of request and the second protocol. The method also includes retrieving a selected piece of information from a selected element of the first request. The selected element of the first request does not match an element of the second type of request. The method also includes generating a second request by mapping the selected piece of information from the selected element of the first request to a selected element of the second type of request. The method also includes processing the second request and sending the second request to the second endpoint based on the processing of the second request.

In more particular embodiments the selected element of the first request and the selected element of the second type of request may be a contact header, a caller preference, a session description protocol element, a faststart element, or a bearer capabilities element. The first and second protocol may be a session initiation protocol (SIP), a H.323 protocol, a real-time transport protocol (RTP), a media gateway control protocol (MGCP), or a skinny client control protocol (SCCP). The selected piece of information may be an indication of a desired medium for the communication.

Where the method includes mapping the selected piece of information from the selected element of the first request to the selected element of the second type of request the method may include mapping a video caller preference in a contact header of a session initiation protocol invite to a digital information bearer capabilities field of an H.323 request.

In accordance with another embodiment of the present invention, a system for providing communication protocol interoperability, includes an interface operable to receive a first request from a first endpoint for communication with a second endpoint. The first endpoint may use a first type of request of a first protocol, and the second endpoint may use a second type of request of a second protocol. The first type of request and first protocol may be different than the second type of request and the second protocol. The system may also include a processor coupled to the interface and operable to retrieve a selected piece of information from a selected element of the first request. The selected element of the first request does not match an element of the second type of request. The processor may also be operable to generate a second request by mapping the selected piece of information from the selected element of the first request to a selected element of the second type of request. The processor may also be operable to process and send the second request to the second endpoint based on the processing of the second request.

Technical advantages of particular embodiments of the present invention include preserving information concerning an endpoint when the endpoint is attempting to establish a communication session with an endpoint of a different communication protocol. Accordingly, the desire of one endpoint to participate in a particular type of communication session (e.g. a video call) is preserved regardless of whether the other endpoint uses the same type of information. Another technical advantage is that determining the desired type of communication may be useful in routing the call to an appropriate endpoint. Accordingly, the endpoints communication experience may be improved.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 is a simplified block diagram that illustrates a communication system for providing a communication protocol interoperability feature in accordance with a particular embodiment of the present invention;

FIG. 2 is a simplified block diagram that illustrates an interoperability gateway of the present invention; and

FIG. 3 is a simplified flowchart that illustrates an example method for providing communication protocol interoperability in accordance with an embodiment of the present invention.

### DESCRIPTION OF EXAMPLE EMBODIMENTS

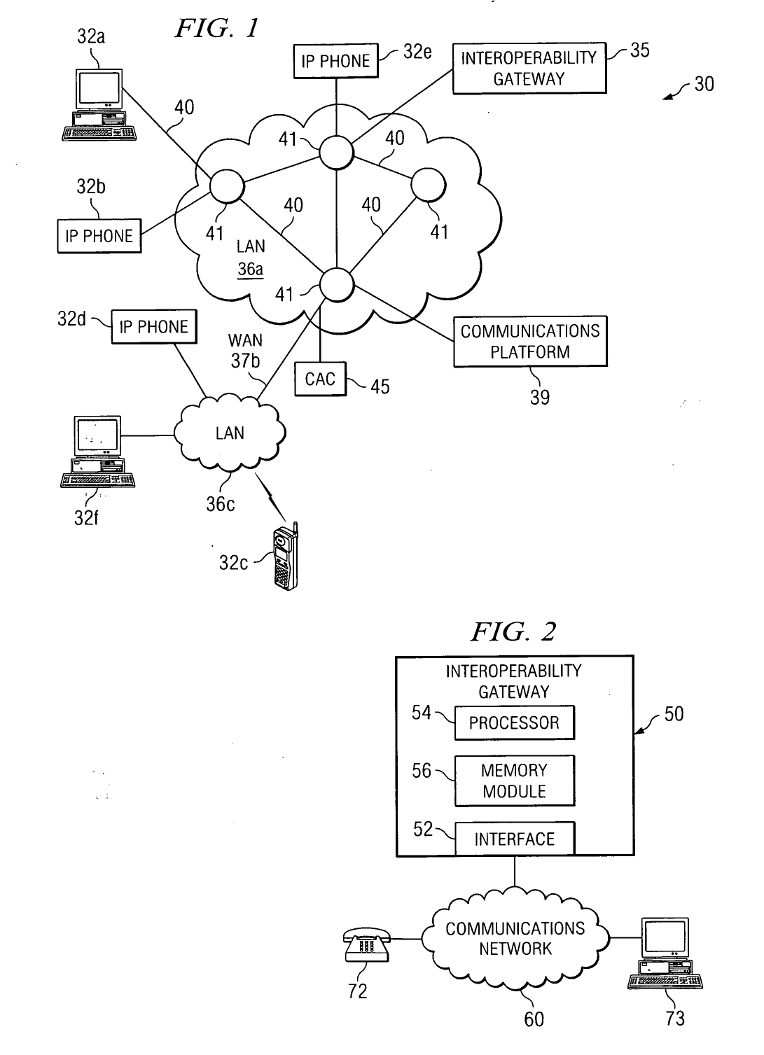

FIG. 1 illustrates a communication system 30 including a plurality of endpoints 32a-32f having the ability to establish communication sessions between each other using one or more of communication networks 36a-36c. Endpoints 32a-32f, interoperability gateway (IG) 35 and communications platform 39 may have the ability to communicate control protocol signals between each other. The control protocols used may be any protocol used in establishing communication sessions between two or more endpoints, such as session initiation protocol (SIP) or H.323. The control protocols may be used to facilitate establishing communication sessions using different forms of communication such as voice over internet protocol (VoIP), video over IP or any other form of communication that uses packets to transmit communications from one endpoint to another. A communication session shall include the sending or receiving of any type of media transmitted using any audio, video and/or data means through any suitable technology such as voice devices or instant messaging.

In particular embodiments, a request may be received at IG 35 or communications platform 39 from one endpoint to connect to another endpoint for a communication session in which the two endpoints may use different communication protocols in establishing the communication session. Because the two endpoints are using different communication protocols it may be that information concerning one endpoint's desire can not directly be communicated to the other endpoint. To avoid losing the information IG 35 may take different pieces of information from different elements of the request and use the information in routing and/or connecting the endpoint to another endpoint that may use a different communication protocol.

In the illustrated embodiment, communication network 36a is a local area network (LAN) that enables communication sessions between a plurality of endpoints 32a-32f and communications between endpoints 32, communications platform 39, and IG 35. The LAN can be distributed across multiple cities and geographic regions. Communication network 36c is another LAN, which couples endpoints 32c, 32d, and 32f with communication network 36a. Accordingly, users of endpoints 32a-32f, can establish calls, media sessions, or communication sessions between and among each network component coupled for communication with network 36a and/or 36c. In the illustrated embodiment, communication link 37b is a wide area network (WAN), which couples LANs 36a and 36c. A call admission control (CAC) system 45 may be used to monitor and police the bandwidth available over WAN 37b.

IG 35, in particular embodiments, may be functionally located between endpoints such that it may facilitate the establishment of communication sessions between endpoints, in particular it may facilitate establishing communication sessions between endpoints using different protocols for establishing communication sessions. IG 35 may be a standalone device or it may be incorporated within any of a variety of different components within a communication network, such as communications platform 39 or a session border controller. Regardless of where IG 35 is physically located, it may still be capable of facilitating the connection of endpoints for communication sessions.

In the illustrated embodiment, communication system 30 includes communications platform 39 that facilitates communication among users and maintains information on users of system 30. For example, communications platform 39 may facilitate connecting endpoint 32a which may be using SIP with endpoint 32f which may be using H.323. In some embodiments, communications platform 39 may monitor endpoints of the communication system and transmit information regarding the status of various endpoints and/or calls. Communications platform 39 may also provide other functionalities typically provided by communications platforms in communication systems.

Thus, the endpoints include hardware and/or software that is operable to receive and to transmit data (directly or indirectly) and to implement the interoperability feature as outlined herein. Note that the term “endpoint” encompasses a myriad of potential devices and infrastructures that may benefit from the operations of communication system 30. An endpoint may be a personal digital assistant (PDA), a cellular telephone, a standard telephone (which may be coupled to a personal computer) an IP telephone, a personal computer, a laptop computer, a mobile telephone, or any other suitable device or element (or any appropriate combination of these elements) that is operable to receive data or information. Each endpoint may also include suitable network equipment and appropriate infrastructure (e.g., switches, routers, LANs, gateways, etc.) to facilitate a SIP session. FIG. 1 illustrates only one set of example devices that may be used within communication system 30. The present invention is replete with numerous alternatives that could be used to facilitate the operations of communication system 30.

It should also be noted that the internal structure of the endpoints are malleable and can be readily changed, modified, rearranged, or reconfigured in order to achieve their intended operations as they pertain to the interoperability function. Note also that the endpoints can each include a link to communications platform 39, which is operable to communicate with any number of endpoints/user agents/devices. In one embodiment, communications platform 39 is a CallManager element, which is manufactured by Cisco Systems, Inc. of San Jose, Calif. The CallManager element is SIP-enabled, and it can readily accommodate other protocols (e.g., H.323). In other embodiments, communications platform 39 is any suitable component (e.g. a gateway, a switch, a router, a bridge, a state machine, a processor, etc.) that is operable to interface with endpoints/end-user.

Software and/or hardware may reside in communications platform 39 in order to achieve the teachings of the interoperability feature of the present invention, as outlined herein. However, due to its flexibility, communication platform 39 may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of communications platform 39 in the context of communication system 30 and, accordingly, it should be construed as such.

Communication network 36a includes a plurality of segments 40 and nodes 41 that couple endpoints 32a, 32b, and 32e with IG 35, communications platform 39 and communication networks 36b-36c. Therefore, a user of endpoint 32a is provided with access to endpoints 32b-32f. Furthermore, endpoints 32a-32f, IG 35, and communications platform 39 may all communicate control and data signals among each other. Nodes 41 may include any combination of network components, gatekeepers, communications platforms, conference bridges, routers, hubs, switches, gateways, endpoints, or other hardware, software, or embedded logic implementing any number of communication protocols that allow for the exchange of packets in communication system 30.

Although the illustrated embodiment includes three communication networks 36a-36c, the term “communication network” should be interpreted as generally defining any network capable of transmitting audio and/or video telecommunication signals, data, and/or messages, including signals, data or messages transmitted through text chat, instant messaging, and e-mail. Any one of networks 36a-36c may be implemented as a local area network (LAN), wide area network (WAN), global distributed network such as the Internet, Intranet, Extranet, or any other form of wireless, or wireline communication network. In addition, communication networks in accordance with various embodiments may include any number of communications platforms 39 or IGs 35. Generally, network 36a provides for the communication of packets, cells, frames, or other portions of information (generally referred to as packets herein) between endpoints 32a-32f as part of the call as well as any control signals that may be needed. Communication network 36a may include any number and combination of segments 40, nodes 41, endpoints 32a-32f.

In a particular embodiment, communication network 36a employs voice communication protocols that allow for the addressing or identification of endpoints, nodes, and/or communications platforms coupled to communication network 36a. For example, using internet protocol (IP), each of the components coupled together by communication network 36a in communication system 30 may be identified in information directed using IP addresses. In this manner, network 36a may support any form and/or combination of point-to-point, multicast, unicast, or other techniques for exchanging media packets among components in communication system 30. Any network components capable of exchanging audio, video, or other data using frames or packets are included within the scope of the present invention.

Network 36a may be directly coupled to other IP networks including, but not limited to, another LAN or the Internet. Since IP networks share a common method of transmitting data, telecommunication signals may be transmitted between telephony devices located on different, but interconnected, IP networks. In addition to being coupled to other IP networks, communication network 36a may also be coupled to non-IP telecommunication networks through the use of interfaces or components, for example communication network 36a may be coupled with a PSTN network through a gateway. A PSTN network includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths. Unlike a circuit-switched network (like PSTN), a dedicated circuit is not required for the duration of a call or fax transmission over IP networks.

Technology that allows telecommunications to be transmitted over an IP network may comprise Voice over IP (VoIP), or simply Voice over Packet (VOP). In the illustrated embodiment, endpoints 32a-32f, IG 35, and communications platform 39 may include IP telephony capabilities allowing them to participate in and/or monitor IM, audio, video, and other multimedia communication sessions. Endpoints 32a-32f may use different protocols, such as SIP or H.323, in setting up multimedia communication sessions. IP telephony devices may include telephones, fax machines, computers running telephony software, nodes, gateways, wired or wireless devices, hand held PDAs, or any other device capable of performing telephony functions over an IP network.

Communication system 30 may receive and transmit data in a session initiation protocol (SIP) environment. SIP is an application-layer control protocol that includes primitives for establishing, modifying, and terminating communication sessions. SIP works independently of underlying transport protocols and without dependency on the type of session that is being established. Communication system 30 may also receive and transmit data in a H.323 environment. H.323 is a protocol used to provide for communication sessions on a packet network and works without dependency on the type of communication session that is being established. There may be significant overlap between the two protocols, however each protocol includes some features that are not directly mirrored in the other, causing conflicts or potential information loss when attempting to establish a communication session between endpoints using the two different protocols.

It will be recognized by those of ordinary skill in the art that endpoints 32a-32f, IG 35, and/or communications platform 39 may be any combination of hardware, software, and/or encoded logic that provides communication services to a user. For example, endpoints 32a-32f may include a telephone, a computer running telephony software, a video monitor, a camera, an IP phone, a cell phone or any other communication hardware, software and/or encoded logic that supports the communication of packets of media (or frames) using communication network 36a. Endpoints 32a-32f may also include unattended or automated systems, gateways, other intermediate components, or other devices that can establish calls. Although FIG. 1 illustrates a particular number and configuration of endpoints, segments, nodes, and gateways, communication system 30 contemplates any number or arrangement of such components for communicating media. In addition, elements of communication system 30, such as communications platform 39, may include components centrally located (local) with respect to one another or distributed throughout communication system 30.

FIG. 2 illustrates an interoperability gateway (IG) 50, which may be similar to IG 35 of FIG. 1. Although FIG. 2 depicts IG 50 as being a standalone device, it may be incorporated within another device such as a session border controller or a communications platform. The functionality described herein with respect to IG 50 applies to other devices or components that may incorporate IG 50 or provide a similar interoperability service. In the illustrated embodiment, IG 50 includes an interface 52, a processor 54, and a memory module 56.

Interface 52 couples IG 50 with communication network 60 and is operable to receive communications from, and transmit communications to, a communication network 60. Processor 54 may be a microprocessor, controller, or any other suitable computing device, resource, or combination of hardware, software and/or encoded logic. Processor 54 may perform communication protocol interoperability functionality described herein with respect to particular embodiments. Memory module 56 may be any form of volatile or non-volatile memory including, without limitation, magnetic media, optical media, random access memory (RAM), read-only memory (ROM), removable media, or any other suitable local or remote memory component. Memory module 56 may store any suitable information to implement features of various embodiments, such as a database, chart or some other organization of data that associates elements of a request in one communication protocol to elements of a request in a different communication protocol.

In the illustrated embodiment, IG 50 is coupled to endpoints 72 and 73 through communication network 60. Communication network 60 may include one or more communication networks and other suitable components, as described above with respect to communication system 30 of FIG. 1.

Endpoints 72 and 73 may use different communication protocols to set up communication sessions. In the illustrated embodiment, endpoint 72 may be an IP phone that uses SIP to establish communication sessions and endpoint 73 may be a PC that uses H.323 to establish communication sessions. Other embodiments may include more endpoints, use different types of endpoints, and/or include endpoints using different communication protocols such as real-time transport protocol (RTP), media gateway control protocol (MGCP) or skinny client control protocol (SCCP).

The following example is crafted to more clearly illustrate some of the functionality of the present invention. In this example endpoint 72 sends a request to establish a communication session with endpoint 73. Endpoint 72 is a SIP endpoint and endpoint 73 is a H.323 endpoint. It may be that the request is sent specifically to endpoint 73 (e.g. a user of endpoint 72 dialed endpoint 73's extension) or the request may be sent to an intermediate point to be routed to endpoint 73 (e.g. a user of endpoint 72 wants technical support and so calls a company's general phone number which connects endpoint 72 to a communications platform for routing to the best available endpoint). Furthermore, for this example, endpoint 72 desires to establish a video communication session with endpoint 73. There may be two ways in which endpoint 72 may communicate its desire for a video call. The first way may be to offer a session description protocol (SDP) that contains video base media. The second way may be to provide a video caller preference in the contact header. Because H.323 does not use SDP or contact headers, in order for endpoint 72's desire to be communicated to endpoint 73, the information will have to be mapped into a request that endpoint 73 can understand.

IG 50 may use a combination of processor 54 and memory 56 to examine endpoint 72's request to determine that endpoint 72 desires a video communication session. Once this desire has been terminated it may be used in a variety of ways. For example, the information could be used in converting the SIP request to a H.323 request by setting the bearer capability of a H.323 request to digital information (restricted or unrestricted) or by using a proper faststart element for a H.323 endpoint. The information may also be used in routing the call where IG 50 already knows the capabilities of the H.323 endpoints connected to it. For example, IG 50 may know that endpoint 73 can handle video calls if endpoint 73 uses fast-start, and its fast-start capabilities state that it has video capabilities, or endpoint 73 could otherwise already be configured with IG 50 as a video endpoint (e.g. all H.323 endpoints connected to IG 50 may have video capabilities).

While the example above illustrated a SIP endpoint requesting to communicate with a H.323 endpoint a similar but reversed process may be used in connecting a H.323 endpoint to a SIP endpoint. More specifically, IG 50 may examine a H.323's signaling, faststart element or bearer capability to determine whether the H.323 endpoint may desire a video call. This information may then be used in setting the caller preference for a SIP endpoint. Additionally, a similar process may be used to communicate other desires of the endpoint that may be using other communication protocols.

It will be recognized by those of ordinary skill in the art that IG 50 is merely one example configuration of an IG for providing interoperability between endpoints using different communication protocols, in accordance with an embodiment of the present invention. Other IGs may include any number of interfaces, processors, memory modules, and/or other components to accomplish the functionality and features described herein. For example, although IG 50 is illustrated and described as including interface 52, processor 54, and memory module 56 these components and other desired components for performing the above described functionality may be centrally located (local) with respect to one another, or distributed throughout communication network 60. Furthermore, as mentioned above IG 50, or its equivalent functionality, may be a stand alone device or it may be integrated within a larger component or system, such as a session border controller or a communications platform.

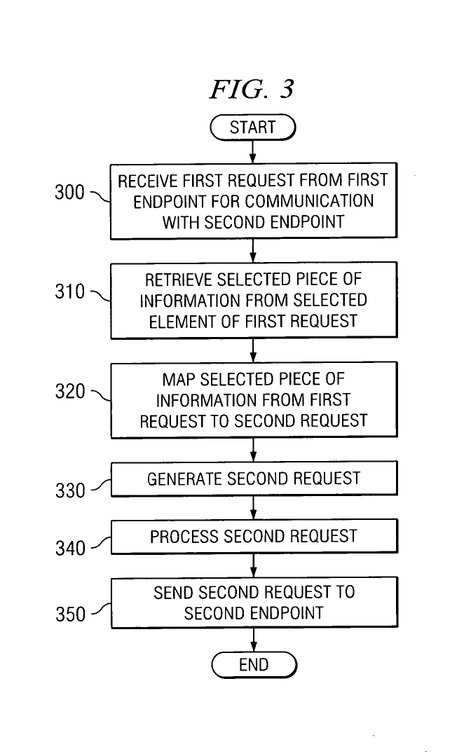

FIG. 3 is a flowchart illustrating a method for providing communication protocol interoperability in accordance with an embodiment of the present invention. To aid in the discussion of the steps depicted in FIG. 3 assume that a SIP endpoint wants to have a video call with a H.323 endpoint. The method begins at step 300 where a request for communication is received from the SIP endpoint. The request may be received at a communications platform, interoperability gateway or any other component coupling the two endpoints using different communication protocols.

The request may be an invite with an offer, where the offer includes an SDP which may contain information concerning the SIP endpoint's desire for a video call. Information from the SIP request may be retrieved, for example, by a communications platform at step 310. The information may be retrieved from one or more different elements of the request. For example, a desire to participate in a video call may be retrieved from the contact header (e.g. the caller preference may indicate a video caller preference) or the SDP (e.g. the SDP contains video base media).

At step 320, the information retrieved at step 310 is mapped to a corresponding H.323 request. It may be the case that information from one SIP element has to be entered in several H.323 elements, or information from several SIP elements may only be entered in a single H.323 element. For example, if the request from the SIP endpoint did not include SDP, the H.323 request may still account for the SIP endpoint's desire for a video call by setting the bearer capability of the H.323 request to digital information if the SIP request's caller preferences includes video.

Once the SIP request's desires have been determined, at step 330 the information determined at step 320 may be used to format a request that the H.323 endpoint will understand. At step 340 the H.323 request may then be processed. Depending on the embodiment and/or the situation, the processing of the request may be done different ways for different reasons. For example, if the SIP request is received at a communications platform, the communications platform may process the request to determine to which H.3232 endpoint the SIP endpoint should be connected. In some instances it may be that the information from the SIP request is processed before the H.323 request is generated.

Once the desire of the SIP endpoint has been determined, mapped to a H.323 request, and processed to determine to which H.323 endpoint to send the request, at step 350 the request is actually sent. This may involve any of a number of steps, signaling and/or communication needed to set up the H.323 endpoint and establish a communication session between the two endpoints.

Some of the steps illustrated in FIG. 3 may be combined, modified or deleted where appropriate, and additional steps may also be added to the flowchart. Additionally, steps may be performed in any suitable order without departing from the scope of the invention.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and IG 50, these elements may be combined, rearranged or positioned in order to accommodate particular routing architectures or needs. In addition, any of these elements may be provided as separate external components to communication system 30, IG 50 or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for providing communication protocol interoperability, comprising:
receiving a first request from a first endpoint for communication with a second endpoint, wherein the first endpoint uses a first type of request of a first protocol, and the second endpoint uses a second type of request of a second protocol, the first type of request and first protocol being different than the second type of request and the second protocol;
retrieving a selected piece of information from a selected element of the first request, the selected element of the first request does not match an element of the second type of request;
generating a second request by mapping the selected piece of information from the selected element of the first request to a selected element of the second type of request;
processing the second request; and
sending the second request to the second endpoint based on the processing of the second request.

2. The method of claim 1, wherein the selected element of the first request is an element selected from the group consisting of:
a) a contact header;
b) a caller preference;
c) a session description protocol element;
d) a faststart element; and
e) a bearer capabilities element.

3. The method of claim 1, wherein the selected element of the second type of request is an element selected from the group consisting of:
a) a contact header;
b) a caller preference;
c) a session description protocol element;
d) a faststart element; and
e) a bearer capabilities element.

4. The method of claim 1, wherein the first protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

5. The method of claim 1, wherein the second protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

6. The method of claim 1, wherein the selected piece of information comprises an indication of a desired medium for the communication.

7. The method of claim 1, wherein generating a second request by mapping the selected piece of information from the selected element of the first request to the selected element of the second type of request comprises generating a second request by mapping a video caller preference in a contact header of a session initiation protocol invite to a digital information bearer capabilities field of an H.323 request.

8. A system for providing communication protocol interoperability, comprising:
an interface operable to receive a first request from a first endpoint for communication with a second endpoint, wherein the first endpoint uses a first type of request of a first protocol, and the second endpoint uses a second type of request of a second protocol, the first type of request and first protocol being different than the second type of request and the second protocol; and
a processor coupled to the interface and operable to:
retrieve a selected piece of information from a selected element of the first request, the selected element of the first request does not match an element of the second type of request;
generate a second request by mapping the selected piece of information from the selected element of the first request to a selected element of the second type of request;
process the second request; and
send the second request to the second endpoint based on the processing of the second request.

9. The system of claim 8, wherein the selected element of the first request is an element selected from the group consisting of:
a) a contact header;
b) a caller preference;
c) a session description protocol element;
d) a faststart element; and
e) a bearer capabilities element.

10. The system of claim 8, wherein the selected element of the second type of request is an element selected from the group consisting of:
a) a contact header;
b) a caller preference;
c) a session description protocol element;
d) a faststart element; and
e) a bearer capabilities element.

11. The system of claim 8, wherein the first protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

12. The system of claim 8, wherein the second protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

13. The system of claim 8, wherein the selected piece of information comprises an indication of a desired medium for the communication.

14. The system of claim 8, wherein the processor operable to generate a second request by mapping the selected piece of information from the selected element of the first request to the selected element of the second type of request comprises a processor operable to generate a second request by mapping a video caller preference in a contact header of a session initiation protocol invite to a digital information bearer capabilities field of an H.323 request.

15. Logic embodied in a computer readable medium, the computer readable medium comprising code operable to:
receive a first request from a first endpoint for communication with a second endpoint, wherein the first endpoint uses a first type of request of a first protocol, and the second endpoint uses a second type of request of a second protocol, the first type of request and first protocol being different than the second type of request and the second protocol;
retrieve a selected piece of information from a selected element of the first request, the selected element of the first request does not match an element of the second type of request;
generate a second request by mapping the selected piece of information from the selected element of the first request to a selected element of the second type of request;
process the second request; and
send the second request to the second endpoint based on the processing of the second request.

16. The medium of claim 15, wherein the selected element of the first request is an element selected from the group consisting of:
a) a contact header;
b) a caller preference;
c) a session description protocol element;
d) a faststart element; and
e) a bearer capabilities element.

17. The medium of claim 15, wherein the selected element of the second type of request is an element selected from the group consisting of:
a) a contact header;
b) a caller preference;
c) a session description protocol element;
d) a faststart element; and
e) a bearer capabilities element.

18. The medium of claim 15, wherein the first protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

19. The medium of claim 15, wherein the second protocol is a protocol selected from the group consisting of:
a) a session initiation protocol (SIP);
b) a H.323 protocol;
c) a real-time transport protocol (RTP);
d) a media gateway control protocol (MGCP); and
e) a skinny client control protocol (SCCP).

20. The medium of claim 15, wherein the selected piece of information comprises an indication of a desired medium for the communication.

21. The medium of claim 15, wherein the code operable to generate a second request by mapping the selected piece of information from the selected element of the first request to the selected element of the second type of request comprises code operable to generate a second request by mapping a video caller preference in a contact header of a session initiation protocol invite to a digital information bearer capabilities field of an H.323 request.

22. A system for providing communication protocol interoperability, comprising:
means for receiving a first request from a first endpoint for communication with a second endpoint, wherein the first endpoint uses a first type of request of a first protocol, and the second endpoint uses a second type of request of a second protocol, the first type of request and first protocol being different than the second type of request and the second protocol;
means for retrieving a selected piece of information from a selected element of the first request, the selected element of the first request does not match an element of the second type of request;
means for generating a second request by mapping the selected piece of information from the selected element of the first request to a selected element of the second type of request;
means for processing the second request; and
means for sending the second request to the second endpoint based on the processing of the second request.
